(19) United States
(12) Patent Application Publication
(10) Pub. No.: US 2004/0007222 A1
(43) Pub. Date: Jan. 15, 2004

(54) Electronics partitioning for ignition systems with control circuits

(76) Inventors: Albert Anthony Skinner, Anderson, IN (US); Raymond O. Butler JR., Anderson, IN (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/192,834

(22) Filed: Jul. 10, 2002

(51) Int. Cl. F02P 9/00

(52) U.S. Cl. 123/609; 123/647; 123/650; 123/644

(57) ABSTRACT

The electronics partitioning for an ignition system with complex control circuits configures a first ignition coil out of a plurality of ignitions coils for an internal combustion engine to include an electronic circuit, such as a complex integrated circuit, that can be shared with the remainder of the plurality of ignition coils. An appropriate wiring harness is configured so that the remainder of the plurality of ignition coils can use the common, shared integrated circuit in the first ignition coil in response to the operation thereof. The inventive arrangement substantially reduces cost of electronics by a factor that is the reciprocal of the number of ignition coils, as well as increases reliability by reducing the absolute total number of complex integrated circuits.

### BACKGROUND OF THE INVENTION

1. Technical Field

The present invention relates generally to ignition systems for developing a spark firing voltage that is applied to one or more spark plugs of an internal combustion engine.

2. Discussion of the Background Art

Ignition coils are known for use in connection with an internal combustion engine, such as an automobile engine. An ignition coil conventionally includes a primary winding having first and second ends, a secondary winding containing a low voltage end and a high voltage end (configured for connection to a spark plug), and a magnetic circuit. A problem for ignition systems having relatively complex control circuits is the cost of the control circuit itself. That is, for stand-alone ignition coils, the complex control circuit has conventionally been replicated for each ignition coil. For example, ignition systems having an ion sense capability illustrate this characteristic. As general background, ion sense systems use the spark plug gap to monitor combustion and/or knock. It is known that the combustion of an air/fuel mixture in an engine results in molecules in the cylinder being ionized. It is further known to apply a relatively high voltage across, for example, the electrodes of the spark plug just after ignition in order to produce a current between the electrodes. Such current is known as an ion current. The ion current that flows is, generally speaking, proportional to the number of combustion ions present in the area of, for example, the spark plug gap referred to above. Additionally, the level of such ion current may provide some measure of the level of ionization throughout the entire cylinder as combustion occurs. The DC level or amount of ion current is indicative of the quality of the combustion event, or whether in fact combustion has occurred at all. (e.g., a misfire condition). An AC component of the ion current may be processed to determine the presence of knock. In view of the relative complexity of the above functions performed by an ion sense system, it is known to embody the control circuitry in an integrated circuit (IC). However, as mentioned above, for ignition systems using stand alone ignition coils, this means providing separate (identical) ICs for each ignition coil, driving up overall cost, and potentially decreasing reliability.

One approach that is known in the art is to provide an arrangement wherein multiple ignition coils are included as part of a cartridge or cassette unit having a system connector for connection to a main control unit, such as an engine control unit (ECU). FIG. 1, in this regard, shows an ignition cassette arrangement 10 coupled by way of a wiring harness 12 or the like to a main control unit such as an ECU 14. The ignition cassette arrangement 10 may include a circuit board 16 having shared or common circuitry contained in a housing 18 for use with a plurality of ignition coils 20₁, 20₂, 20₃, and 20₄. An example of this sort of arrangement may be seen by reference to U.S. Pat. No. 4,706,639 entitled “Integrated Direct Ignition Module” issued to Boyer et al. It may be observed that such an arrangement would provide the capability of deploying circuitry, perhaps an integrated circuit (IC), that could be shared by multiple ignition coils. A single integrated circuit that can service multiple ignition coils would be cheaper than a plurality of integrated circuits, one for each ignition coil. However, there are a variety of circumstances where a cassette (i.e., an integrated system) cannot be packaged and used and thus where individual ignition coils must be deployed. In such circumstances, the known art continues to be characterized with the cost disadvantages and reliability issues described above.

Accordingly, there is a need for an ignition system that minimizes or eliminates one or more of the problems referred to above.

### SUMMARY OF THE INVENTION

One object of the present invention is to provide a solution to one or more of the problems as set forth above. An ignition system in accordance with the present invention overcomes the shortcomings of conventional ignition systems by providing the ability to share circuitry, including complex integrated circuits (ICs), among multiple ignition coils without requiring a common housing, such as a cassette. Thus, one advantage of the present invention is that it provides a reduced cost relative to systems known in the art. In addition, the present invention provides for increased reliability inasmuch as fewer circuits, for example, fewer integrated circuits (ICs) per single engine application, would improve the reliability on a per vehicle basis.

An ignition system in accordance with the present invention is configured for use with an internal combustion engine and includes a first ignition coil, and at least a second ignition coil. The first ignition coil has an electronic circuit. The second ignition coil is coupled to the first ignition coil wherein the electronic circuit is responsive to the operation of the second ignition coil.

In a preferred embodiment, the electronic circuit comprises an integrated circuit (IC), and the coupling between the first ignition coil and the second and subsequent ignition coils (if any) are made using a wiring harness. The wiring harness provides packaging flexibility that a rigid cassette cannot.

A method of packaging an ignition system is also presented.

### BRIEF DESCRIPTION OF THE DRAWINGS

The present invention will now be described by way of example, with reference to the accompanying drawings.

FIG. 1 is a simplified, perspective view of a cassette-based ignition system known in the art.

FIG. 2 is a simplified, perspective view of an ignition system in accordance with the present invention.

FIG. 3 is a simplified schematic and block diagram view showing a partitioning arrangement of a first, preferred ignition system embodiment according to the present invention having an exemplary ion sense integrated circuit.

FIG. 4 is a simplified schematic and block diagram view of a second ignition system embodiment according to the present invention.

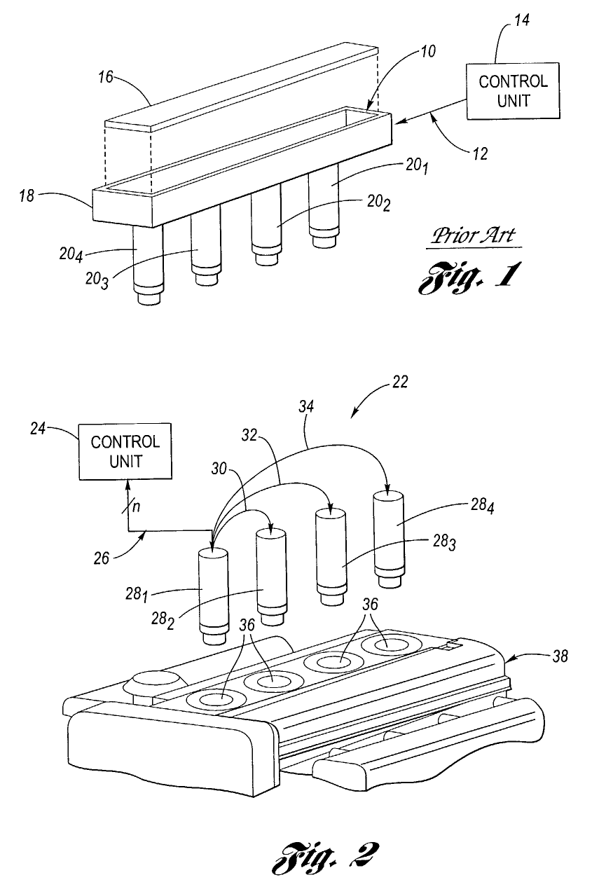

### DETAILED DESCRIPTION OF THE PREFERRED EMBODIMENTS

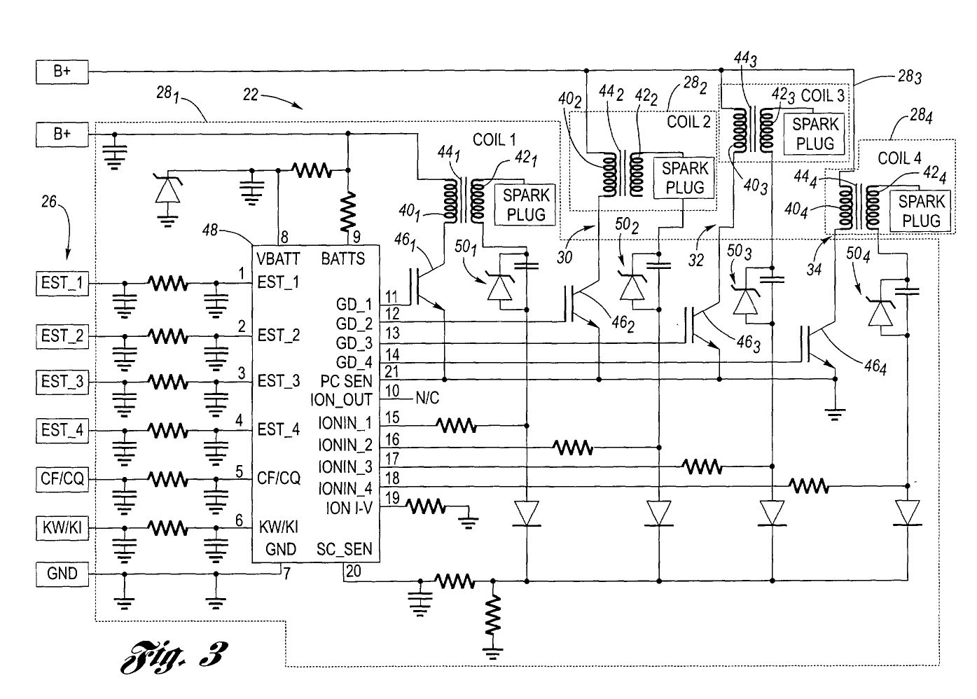

Referring now to the drawings wherein like reference numerals are used to identify identical components in the various views, FIG. 2 is a simplified perspective view of an ignition system 22 in accordance with the present invention. FIG. 2 further illustrates a main control unit 24, a main multi-conductor wiring harness 26, and a plurality of ignition coils 28₁, 28₂, 28₃ and 28₄. FIG. 2 also shows one or more inter-coil wiring harness connections designated 30, 32 and 34 and a plurality of spark plug access wells 36 in an internal combustion 38.

Ignition system 22 is adapted for installation to conventional internal combustion engine 38. Internal combustion engine 38 may include a plurality of spark plug access wells 36, as noted above. In the embodiment shown in FIG. 2, the ignition system 22 is configured for installation by disposing the respective distal ends of each ignition coil 28₁, 28₂, 28₃ and 28₄ through the spark plug wells 36 onto a respective high-voltage terminal of the respective spark plug (not shown). It should be understood that the number of ignition coils will generally be equal to the number of spark plugs (and thus cylinders) in a conventional arrangement, although other variations are clearly possible (e.g., two, three, five, six, eight, ten, etc.). Each spark plug, as known, may be retained by threaded engagement with the spark plug opening in a combustion cylinder in engine 38. Engine 38 may provide power for locomotion at the self-propelled vehicle, such as an automotive vehicle.

As is generally known, the ignition coils 28₁, 28₂, 28₃ and 28₄ may be coupled to, for example, a control unit 24, which may be configured to control the operation of each ignition coil. Control unit 24 may comprise a engine control unit (ECU) or the like containing electronics and other conventional hardware and software as eluded to above. In particular, control unit 24 may be configured to determine when charging of a particular coil is to commence for each cylinder, and for how long, and when spark events should occur relative to a crank shaft position, for example. Control unit 24 then generates electrical signals (e.g., one or more electronic spark timing (EST) signals) as may be required to implement an operating strategy as outlined above. In all salient respects, control unit 24 may comprise a conventional apparatus known to those of ordinary skill in the art, and therefore will not be described in any further detail.

Ignition coils 28₁, 28₂, 28₃ and 28₄ have a relatively slender configuration adapted for mounting directly above the spark plug—commonly referred to as a “pencil” coil. As will become apparent below, the improvements occasioned by the present invention involve modification of a first one of the ignition coils, for example, 28₁, in a manner different from the modifications to the remainder of the ignition coils, for example 28₂ through 28₄. The ignition coils 28₁, 28₂, 28₃ and 28₄ are in physically separate packages, connected by the wiring connections 30, 32 and 34. A detailed description of the ignition coil 28ᵢ is not necessary for a proper understanding of the present invention, nonetheless, each ignition coil 28ᵢ includes at least a primary winding, a secondary winding having a high voltage end configured for connection to a spark plug, and a magnetic circuit that includes at least a generally cylindrical, central main core, and an outer, annular side core. Both cores may be made from magnetically-permeable material.

As described in the Background, to implement circuitry, for example, complex control circuits such as ion sense systems, the conventional art has taught including such circuitry (e.g., in the form of an integrated circuit) in each ignition coil. This arrangement, however, results in a cost penalty for the overall system, and perhaps a decreased reliability (resulting from a numerically increased number of parts).

In accordance with the present invention, the subject electronics are partitioned so that they are physically located in one ignition coil and configured to be shared with the remaining ignition coils. An ignition system for an internal combustion engine is thus provided where a first ignition coil, such as ignition coil 28₁, has an electronic circuit associated therewith. One or more additional ignition coils, such as ignition coils 28₂, 28₃ and 28₄, are coupled to the first ignition coil 28₁. The electronic circuit that is located in the first ignition coil 28₁, is shared with the other ignition coils, so that, in-effect, such electronic circuit is responsive to the operation of the second, and further additional ignition coils (if any). The electronic circuit, generally speaking, may be modified so that it can be shared with the other ignition coils. For example, rather than, in the illustrated embodiment, four separate single-channel ion sense ICs, a single, four-channel IC may be provided in the main ignition coil 28₁. Similar modifications may be made, depending on the nature of the electronic circuit. In addition, the inter-coil wiring connections are characterized by an element of flexibility in packaging, wherein in contrast a cassette (i.e., a rigid housing) does not.

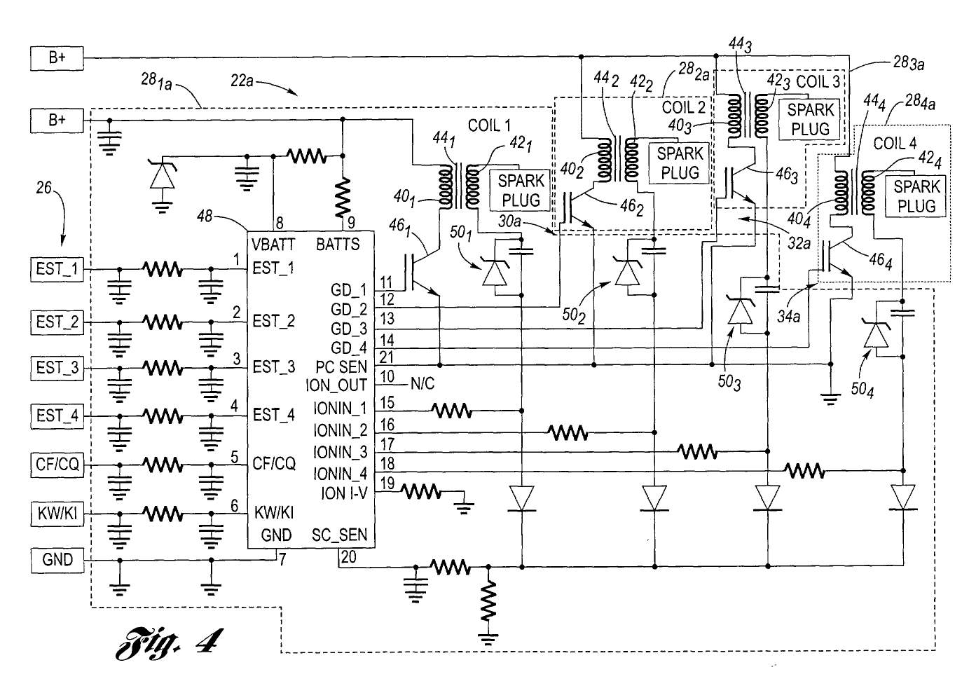

FIG. 3 and FIG. 4 illustrate the broad aspects of the present invention where the electronic circuit comprises an ion sense integrated circuit (IC) and where a cassette cannot be packaged and thus individual coils are required. FIG. 3 specifically shows a first embodiment of ignition system 22 where the first ignition coil 28₁, contains an electronic circuit (i.e., a multi-channel ion sense IC) configured to be shared with other ignition coils, as well as the main primary current driver for each ignition coil and the remaining support circuitry. FIG. 4, on the other hand, illustrates an alternate embodiment where the electronic circuit (i.e., the multi-channel ion sense IC) is included in first ignition coil 28₁, but where the other ignition coils in the ignition system each contain its own primary current driver device (e.g., an IGBT). The embodiment of FIG. 4 is particularly suited to the situation where the packaging size or geometry precludes including all of the main, primary current driver devices in the first ignition coil package.

Referring to FIG. 3, ignition system 22 includes first ignition coil 28₁, having the shared electronic circuit, as well as one or more additional ignition coils 28₂, 28₃ and 28₄ that are each coupled to the first ignition coil 28₁. FIG. 3 shows, in this regard, that ignition coil 28₄, includes a primary winding 40₁, a secondary winding 42₁, and a magnetic core 44₁, as known. Likewise ignition coil 28₂includes a corresponding primary winding 40₂, a corresponding secondary winding 42₂, and a corresponding magnetic core 44₂. Ignition coil 28₃ includes a corresponding primary winding 40₃, a corresponding secondary winding 42₃, and a corresponding magnetic coil 44₃. Ignition coil 28₄ includes a corresponding primary winding 40₄, corresponding secondary winding 42₄, and a corresponding magnetic core 44₄. However, first ignition coil 28₁, in the illustrated embodiment, includes a primary current driver device, such as an insulated gate bipolar transistor (IGBT), designated 46₁. First ignition coil 28₁,particularly the packaging/housing therefor, as illustrated, also includes respective primary current driver devices, designated 46₂,46₃, and 46₄ that are associated with the remaining ignition coils 28₂, 28₃and 28₄. The driver devices 46₂-46₄ may also be IGBT devices. The primary current driver devices are provided for controlling respective primary currents in the ignition coils 28₁ through 28₄.

First ignition coil 28₁ also includes the above-described electronic circuit, which in the illustrated embodiment comprises a multi-channel, ion sense integrated circuit (IC) 48. The ion sense integrated circuit 48 is configured to sense a respective ion current through a respective spark plug to which each of the ignition coils is connected. In the illustrated embodiment, the ion sense IC 48 includes a variety of inputs. The first group of signal lines are input/outputs with the control unit 24, and, in-effect are part of the main wiring harness 26. A first group of signal lines comprise electronic spark timing (EST) inputs for each of the plurality of ignition coils, respectively designated EST_1, EST_2, EST_3, and EST_4. As discussed above, these signals control when charging of a respective ignition coil is to begin (i.e., EST_1 controls coil 28₁, and so on), how long the charging persists as well as the timing of the spark itself (i.e., when to discharge).

The ion sense IC 48 also has a power source input signal, which may be derived from a vehicle battery, and which is designated B+ in the drawing. Ion sense IC 48 also has a ground input, designated GND.

The CF/CQ signal line is an output from ion sense IC 48, and may comprise a pulse width modulated (PWM) signal indicative of a combustion quality sensed according to an ion sensing strategy.

The KW/KI signal line may be a bi-directional signal line wherein a knock window (KW) signal is provided by control unit 24 to the ion sense IC 48 during a time interval when knock is expected to occur. Ion sense IC 48 may be configured to use the knock window signal (KN) provided thereto as a gating signal to control when the chip attempts to detect knock. That is, the ion sense IC 48 may be configured to process the ion current signal during the assertion of the knock window signal (KW) to determine and produce a knock intensity (KI) signal. The knock intensity (KI) signal may thereafter be transmitted over the KW/KI line back to the control unit 24, which may use such KI signal to make adjustments in its spark timing, fuel delivery, and the like to reduce or eliminate knock (according to known strategies).

The second group of signal lines provided on ion sense IC 48 comprise input/output (I/O) lines to the remaining electronics located in the packaging for first ignition coil 28₁. For example, the signals GD_1, GD_2, GD_3, and GD_4, are outputs from chip 48 and define gate drive signals for respective primary current driver devices 46₁,-46₄, respectively. Asserting the GD_1 signal, for example, commences the flow of primary current through switch 46₁, while deasserting the GD_1 signal turns switch 46₁ off, thus causing a spark (as known).

In addition, in the illustrated embodiment, ion sense IC 48 may be configured as a “make” voltage bias ion sense system, for example as seen by reference to U.S. Pat. No. 6,263,727, issued to Butler, et al. hereby incorporated by reference in its entirety. According to the teachings of such a system, the ion sense control circuit preferably senses a primary current, among other things. The level of primary current may be sensed on the PC_SEN line.

The signal lines IONIN_1, IONIN_2, IONIN_3, and IONIN_4 are provided for receiving ion current signals for the respective ignition coils. Each of these signals is representative of the ion current through the electrode cap of the respectively associated spark plug.

The SC_SEN signal line is an input signal line for a secondary current indicative signal, which represents the level of secondary current through a respective one of the secondary windings of the ignition coils 28₁ through 28₄.

Ignition coil 28₁ further includes ion sense biasing circuitry 50₁, 50₂, 50₃ and 50₄ associated respectively with each of the four ignition coils shown in FIG. 3. As known, a relatively high voltage that occurs during the spark event may be used to reverse break down the zener diodes, which allow the capacitor located in parallel with the zener diode to be changed to substantially the same level as the reverse break down level (e.g., 100 volts). The charge on the respective capacitor may then subsequently be used as a biasing voltage to bias the spark plug for producing ion current, all is known to one of ordinary skill in the art.

FIG. 3 further shows the inter-coil wiring connections 30, 32, and 34. Wiring connection 30, 32 and 34 in the illustrated embodiment each comprise respective primary winding and secondary winding return leads. Wiring connections 30, 32 and 34 may comprise conventional metallic conductors, sized according to well known principals in the art (i.e., as to AWG, insulation, shielding, if any, etc.).

With continued reference to FIG. 3, it should be apparent that the first ignition coil 28₁ contains a 4-channel ion sense integrated circuit 48, a variety of external components for the support of integrated circuit 48, and all of the primary current driver devices (e.g. the IGBTs) in the ignition system 22. The illustrated arrangement allows for a two-wire connection (i.e., inter-coil wiring connections 30, 32 and 34) between main ignition coil 28₁ and each of the remaining ignition coils. The cost of a 4-channel integrated circuit 48 is only slightly more than the cost of a single channel ion sense integrated circuit (not shown); however, for a single-channel ion sense integrated circuit, a total of four (4) of such integrated circuits would be required were each stand alone ignition coil in the illustrated embodiment to be so configured, thereby nearly quadrupling the cost. The foregoing partitioning approach for ignition systems with complex control circuits allows a fairly substantial reduction in the total electronics cost. In addition, the overall reliability is expected to be increased, since numerically fewer integrated circuits would be needed on an overall ignition system basis (i.e., per engine).

FIG. 4 shows an alternate embodiment for an ignition system according to the present invention, designated ignition system 22a. The embodiment of FIG. 4 is similar to the embodiment of FIG. 3, except that each physically separate ignition coil (i.e., in its own separate package) contains its own primary current driver 46₁ through 46₄. The ignition coils in ignition system 22a are designated 28₁ₐ and 28₂ₐ, 28₃ₐ and 28₄ₐ. In addition, the inter-coil wiring connections now each contain three conductors. One of the conductors remains the secondary winding return path. However, the other two conductors are now a respective gate drive signal connection for the primary driver, and a respective emitter lead (i.e., a primary current return) connection. These modified inter-coil wiring connections are designated 30a, 32a, and 34a in FIG. 4. Although the cost savings in FIG. 4 is not as great as that of the embodiment of FIG. 3 (due to the extra wiring required), it nonetheless provides additional flexibility where packaging restraints limit putting all four primary current driver devices in one package (i.e., in the package for the first ignition coil 28₁).

It should be expressly understood that even though the foregoing description, and accompanying illustrations were of a make voltage bias ion sense system, the scope of the present invention is not so limited. The broad aspects of the present invention apply to any ignition system that includes an electronic circuit that can be shared at a lower cost than for individual electronic circuits, including integrated circuits (ICs). For example, in a conventional ignition system, incorporating the circuit that controls the driver devices on one ignition coil, rather than duplicate such control circuit over four ignition coils, would in a similar manner provide a substantial cost reduction. In addition, as referred to above, reliability would also be increased in such an ignition system, inasmuch as the number of integrated circuits would be reduced (per engine application).

It is to be understood that the above description is merely exemplary rather than limiting in nature, the invention being limited only by the appended claims. Various modifications and changes may be made thereto by one of ordinary skill in the art which embody the principles of the invention and fall within the spirit and scope thereof.

1. An ignition system for an internal combustion engine comprising:
a first ignition coil having an electronic circuit; and
a second ignition coil coupled to said first ignition coil, said electronic circuit being responsive to the operation of said second ignition coil.

2. The system of claim 1 wherein said electronic circuit comprises an integrated circuit.

3. The system of claim 2 wherein said first ignition coil is configured to be coupled to a first spark plug for initiating combustion in a first cylinder of said engine and said second ignition coil being configured to be coupled to a second spark plug for initiating combustion in a second cylinder of said engine, said integrated circuit being configured to sense a respective ion current associated with said cylinders during respective combustion cycles.

4. The system of claim 2 wherein said integrated circuit comprises drive circuitry for controlling charging and discharging of said first and second ignition coils.

5. The system of claim 2 wherein said first ignition coil has a first switch associated therewith for controlling primary current of said first ignition coil, said second ignition coil having a second switch associated therewith for controlling primary current of said ignition coil, said first switch being located in said first ignition coil and said second switch being located in said second ignition coil.

6. The system of claim 2 wherein said first ignition coil has a first switch associated therewith for controlling primary current of said first ignition coil, said second ignition coil having a second switch associated therewith for controlling primary current of said second ignition coil, said first switch and said second switch being located in said first ignition coil.

7. The system of claim 2 further comprising a plurality of ignition coils each being configured to use said electronic circuit.

8. An ignition system for a spark ignition internal combustion engine comprising:
(i) a first ignition coil including
a first primary winding and a first secondary winding, said first secondary winding being configured for connection to a first spark plug,
a first switch configured to selectively couple said first primary winding to a power source for producing a first primary current therethrough, and an integrated circuit configured to control said first switch; and
(ii) a second ignition coil including
a second primary winding and a second secondary winding, said second secondary winding being configured for connection to a second spark plug;
wherein said first ignition coil further includes a second switch configured to selectively couple said second primary winding to said power source for producing a second primary current therethrough, said integrated circuit being configured to control said second switch.

9. The system of claim 8 wherein said integrated circuit includes drive circuitry to control said first and second switches.

10. The system of claim 9 wherein said integrated circuit further includes ion sense circuitry configured to bias said first and second spark plugs during respective combustion cycles to produce a respective ion current signal.

11. An ignition system for a spark ignition internal combustion engine comprising:
(i) a first ignition coil including
a first primary winding and a first secondary winding, said first secondary winding being configured for connection to a first spark plug,
a first switch configured to selectively couple said first primary winding to a power source for producing a first primary current therethrough, and an integrated circuit configured to control said first switch; and
(ii) a second ignition coil coupled to said first ignition coil and including
a second primary winding and a second secondary winding, said second secondary winding being configured for connection to a second spark plug;
a second switch configured to selectively couple said second primary winding to said power source for producing a second primary current therethrough;
said integrated circuit being configured to control said second switch.

12. The system of claim 11 wherein said integrated circuit includes drive circuitry to control said first and second switches.

13. The system of claim 12 wherein said integrated circuit further includes ion sense circuitry configured to bias said first and second spark plugs during respective combustion cycles to produce a respective ion current signal.

14. A method of packaging an ignition system comprising the steps of:
(A) providing a first ignition coil that includes an integrated circuit configured to perform a first function associated with the operation of the first ignition coil;
(B) providing a second ignition coil;
(C) providing an interface on each of said first and second ignition coils so as to allow said second ignition coil access to said integrated circuit for performing said first function with respect to the operation of said second ignition coil.

15. The method of claim 14 further including the step of:
selecting said first function from the group comprising a primary switch driver function, and an ion sense function.
